(19) United States
(12) Patent Application Publication
(10) Pub. No.: US 2021/0133690 A1
(43) Pub. Date: May 6, 2021

(54) CREATING SCHEDULES UTILIZING TEMPORAL CONSTRAINTS

(71) Applicant: Ent. Services Development Corporation LP, Houston, TX (US)

(72) Inventors: Joshua HAILPERN, San Jose, CA (US); William J. ALLEN, Corvallis, OR (US); Ronald CALVO, Heredia (CR); Sebastian ALVAREZ, San Jose (CR)

(73) Assignee: Ent. Services Development Corporation LP, Houston, TX (US)

(21) Appl. No.: 17/068,523

(22) Filed: Oct. 12, 2020

Related U.S. Application Data
(63) Continuation of application No. 16/075,419, filed on Aug. 3, 2018, now abandoned.

(51) Int. Cl. G06Q 10/10; G06Q 10/06

(52) U.S. Cl. CPC G06Q 10/1093; G06Q 10/1091; G06Q 10/063114; G06Q 10/06314

(57) ABSTRACT

In one example in accordance with the present disclosure, a method for schedule creation may include interpreting a set of temporal constraints corresponding to a predetermined time period for a user. The set of temporal constraints may include a constraint defining a minimum period of uninterrupted time for a primary job responsibility of the user. The method may also include generating a set of blocks based on the set of temporal constraints. Each block in the set of blocks corresponds to an event to be scheduled during the predetermined time period and each block has a weight. The method may also include creating a schedule including each block in the set of blocks. The schedule may include the minimum period of uninterrupted time for a primary job responsibility of the user.

### CROSS-REFERENCE TO RELATED APPLICATIONS

This application is a continuation of U.S. application Ser. No. 16/075,419, filed Aug. 3, 2018, which is a national stage application pursuant to 35 U.S.C. § 371 of International Application No. PCT/US2016/016505, filed Feb. 4, 2016, all of which are incorporated in their entireties herein by reference.

### BACKGROUND

Workers may use a calendar to block off time and manage appointments. In many cases, users may have to rearrange events on the calendar due to changes in schedules, conflicts, other job responsibilities, etc.

### BRIEF DESCRIPTION OF THE DRAWINGS

The following detailed description references the drawings, wherein:

FIG. 1 is a block diagram of an example system for schedule creation;

FIG. 2 is a flowchart of an example method for schedule creation;

FIG. 3 is a flowchart of an example method for schedule adjustment based on an interruption;

FIG. 4 is a block diagram of an example system for schedule creation; and

FIG. 5 is a block diagram of an example system for schedule creation.

### DETAILED DESCRIPTION

Workers may require certain blocks of uninterrupted time to perform primary job responsibilities (such as writing reports, writing code, doing research, etc.). For example, a programmer may be productive when programming for at least two hours at a time. However, workers may have to balance time spent performing their primary job responsibilities with time spent on meetings, breaks and other activities. In typical professional and personal situations, there may be no regulation on the number and timing of incoming requests for interaction, including emails, IM, phone calls, digital meetings, physical meetings, and others. Entering a meeting on a calendar may help manage meeting times, but may not allow a worker to have enough time or blocks of a certain length to perform primary job responsibilities.

Traditionally, users may manually block out time every week for performing primary job responsibilities. Manually blocking out time on a calendar may not be flexible as schedules and constraints may constantly change. These constant changes may lead to time being used inefficiently and events being missed unnecessarily.

The system for schedule creation may provide a practical, scalable, system to manage primary job responsibilities, handling of requests for interaction and other activities as needed. The system for schedule creation allows a user to express needs for time in terms of constraints rather than in terms of fixed and/or recurring schedule hours. A temporal constraint may indicate or otherwise represent an activity and an amount of time to be allotted for that activity without being assigned to any particular time on any particular calendar date. In some examples, the temporal constraint may be associated with a range of time on a calendar larger than an amount of time to be allotted for an activity indicated in the temporal constraint. Notably: the temporal constraint may include an amount of time for the activity and not a specific time for the activity. For example, a temporal constraint may be “schedule four hours for coding,” rather than entering a calendar appointment to code from 1:00 PM to 5:00 PM on Jan. 15, 2015. Temporal constraints may be time based obligations and/or requests for a user over a given period of time. For example, a set of temporal constraints for a period of time of one week may include “schedule five uninterrupted hours for preparing reports, four hours for reviewing reports, two meetings with a manager spread two days apart and 30 minutes for lunch each day.”

The system may use a series of metrics to auto-balance and reschedule blocks of time based on the changing needs and/or availability of people's schedules and other constraints. For a predetermined period of time (such as a week, bi-week, month, quarter, etc.) an amount time to reserve for primary job responsibilities of a user may be specified as well as the minimum blocks of time for performing these primary job responsibilities (e.g. I need blocks of at least 2 hours each of 4 days per week).

An example method for schedule creation may include interpreting a set of temporal constraints corresponding to a predetermined time period for a user, wherein the set of temporal constraints includes a first constraint defining a minimum period of uninterrupted time for a primary job responsibility of the user. The method may also include generating a set of blocks based on the set of temporal constraints, wherein each block in the set of blocks corresponds to an event to be scheduled during the predetermined time period and each block has a weight. The method may also include creating, based on the set of temporal constraints and the weight of each block in the set of blocks, a schedule including each block in the set of blocks, wherein the schedule includes the minimum period of uninterrupted time for a primary job responsibility of the user.

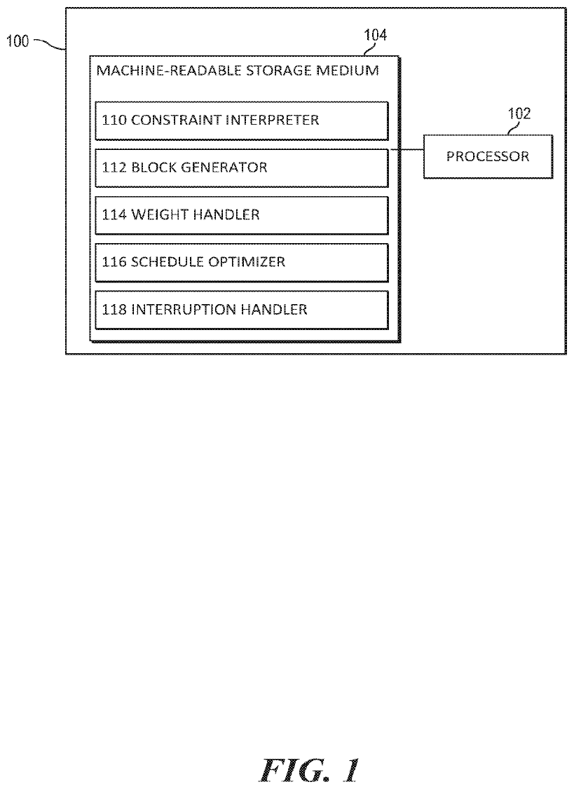

FIG. 1 is a block diagram of an example system 100 for schedule creation. System 100 may include a processor 102 and a memory 104 that may be coupled to each other through a communication link (e.g., a bus). Processor 102 may include a Central Processing Unit (CPU) or another suitable hardware processor. In some examples, memory 104 stores machine readable instructions executed by processor 102 for operating system 100. Memory 104 may include any suitable combination of volatile and/or non-volatile memory, such as combinations of Random Access Memory (RAM), Read-Only Memory (ROM), flash memory, and/or other suitable memory. Memory 104 may also include a random access non-volatile memory that can retain content when the power is off.

Memory 104 stores instructions to be executed by processor 102 including instructions for constraint receiver 110, a block generator 112, a weight handler 114, a schedule optimizer 116 and an interruption handler 118 and/or other components. According to various implementations, system 100 may be implemented in hardware and/or a combination of hardware and programming that configures hardware. Furthermore, in FIG. 1 and other Figures described herein, different numbers of components or entities than depicted may be used.

Processor 102 may execute instructions of constraint interpreter 110 to interpret constraints used in creating a user's schedule. Interpreting constraints may include receiving a constraint and converting the constraint into a format usable by the system 100. For example, constraint interpreter 110 may receive the constraint in plain text and convert the constraint into time requirements. For example, if the constraint is “schedule five uninterrupted hours for preparing reports” constraint interpreter 110 may convert the constraint into a first logic statement for scheduling a five hour block of time and a second logic statement that the block cannot be interrupted. Constraint interpreter 110 may receive a set of temporal constraints corresponding to a predetermined time period for a user. The set of temporal constraints may include a first constraint defining a minimum period of uninterrupted work time for the user. The set of temporal constraints may correspond to time needs of the user during the predetermined time period.

A temporal constraint may indicate or otherwise represent an activity and an amount of time to be allotted for that activity without being assigned to any particular time on any particular calendar date. In some examples, the temporal constraint may be associated with a range of time on a calendar larger than an amount of time to be allotted for an activity indicated in the temporal constraint. Notably, the temporal constraint may include an amount of time to be allotted for the activity and not a specific time for the activity. For example, a temporal constraint may be “schedule four hours for coding,” rather than entering a calendar appointment to code from 1:00 PM to 5:00 PM on Jan. 15, 2015. Temporal constraints may be time based obligations and/or requests for a user over a given period of time. For example, a set of temporal constraints may be “for the week of January 15—schedule five uninterrupted hours for preparing reports, four hours for reviewing reports, two meetings with a manager spread two days apart and 30 minutes for lunch each day.”

Constraint interpreter 110 may allow time requests to be expressed in terms of constraints rather than in terms of fixed and/or possibly recurring schedule hours. For example, a user may enter constraints such as “meet with Person X for 30 minutes once per week, and with at least 1 non-meeting working day between meeting days.” The actual days of weeks and hour of meeting may not be specified, and therefore can be flexibly managed. Additionally, a user may enter a constraint that is a minimum amount and/or block of time to be spent doing a primary job responsibility. As used herein, the term primary job responsibility refers to a user's actual job (such as programming, researching, writing, etc.) as opposed to meetings, holidays, breaks, and other work and/or non-work related activities that may exist and/or be placed on a calendar. In other words, a primary job responsibility and/or a temporal constraint may be a non-meeting event and/or activity.

Constraint interpreter 110 may interpret other types of constraints as well. As described above, interpreting a constraint may include receiving a constraint and converting the constraint. Some of these constraints may be system specified, learned by the system 100 through a machine learning technique, and/or user specified. Constraint interpreter 110 may receive a user constraint defining a date and a time for at least one event and include the user constraint in the set of temporal constraints. Constraint interpreter 110 may interpret a constraint defining a maximum and/or minimum amount of time to be allotted for a particular type of activity during a predetermined time period. For example, users may specify a preference for time constraints (primary job responsibilities, etc.) during different days, times, etc. For example, a user may have specified that they prefer to have lunch from 12-1, that they do not like meetings after lunch on Wednesdays, that they can only participate in events that can be performed on a mobile phone on Tuesdays after 2 PM, etc. Similarly, users may specify buffer times for a break between meetings or work, break after meetings with certain people. Constraint interpreter 110 may use geographical information to automatically calculate walking time based on meeting location. For example, constraint interpreter 110 can use the distance between meeting rooms, etc.

Constraint interpreter 110 may estimate buffer times based on past events and/or known data. Estimating buffer times may include determining a buffer constraint based on the run time of a previous event that occurred during a previous predetermined time period and including the buffer constraint in the set of temporal constraints. Constraint interpreter 110 may automatically determine recurring meetings and/or may calculate estimated “over run” for people/groups. For example, constraint interpreter 110 may determine that, based on past meetings, a meeting between a worker and her manager may typically overrun 20 minutes. Accordingly, receiver may receive as a constraint not to schedule another event until at least 20 minutes after a meeting between a worker and her manager.

Processor 102 may execute instructions of block generator 112 to generate a set of blocks based on the set of temporal constraints (e.g. as discussed herein with respect to constraint interpreter 110). Each block in the set of blocks may correspond to an event to be scheduled during the predetermined time period. Generating a set of blocks may include creating the blocks and assigning a preliminary scheduled time and date for each block. The preliminary scheduled times and dates may be adjusted (e.g. as discussed herein with respect to schedule optimizer 116) over an interim period between a current time and a time that the event corresponding to the block occurs.

Processor 102 may execute instructions of weight hander 114 to determine a base weight for each block to be used in scheduling and rescheduling (e.g. as discussed herein with respect to schedule optimizer 116). The base weight may be determined by and/or correspond to an importance of a temporal constraint, event, block, etc. The importance may be an absolute importance, may be relative to other events, may be relative to other attendees for the event, block, constraint, etc.

Weight handler 114 may adjust a weight of a block based on a variety of factors. These factors may include number of attendees of an event, frequency of an event, location of an event, travel time to event, the weight in other's calendar (if someone cannot move an event because it has high weight, it may also impact others weight as well), room availability for an event, time of day, the flexibility in scheduling an event (for example, schedule on Tuesday vs. schedule next week vs. schedule this quarter). Weight handler 114 may adjust a weight of a block in the schedule based on the proximity of the time block to the end of the predetermined time period. Weight handler 114 may adjust a weight of a block in the schedule based distance between a schedule time for a first event corresponding to the block and a current time. For example, events that are scheduled to occur closer to a current time may have a higher weight than events that are scheduled to occur further away. Accordingly, as an event draws closer, it may be less likely that the event is rescheduled. In this manner, the weight handler 114 may favor events that are about to occur in order to prevent disruptions to schedules.

Weight handler 114 may adjust and/or increate the weight of a block based on an organizational hierarchy of a company employing the user and another participation in a first event corresponding to the block. The organizational hierarchy may include a ranking of importance of roles inside and/or outside of the company in relation to other roles inside and/or outside the company. For example, a senior executive may have more weight than a junior employee. As another example, people in more direct line to the individual may have more weight than others (direct subordinates could more weight than people in a different group). The organizational hierarchy may be stored on and/or retrieved from one or more databases connected to the system 100 (not pictured).

Another factor that may impact the weight of a block is a deadline. For example, a block for primary job responsibilities may receive priority over other events classified as “less productive” when there is an upcoming deadline scheduled.

Users may also manually make an event have a very high weight, and thereby make it less likely or not possible to be rescheduled. For example, a user could manually enter a weight fora birthday, anniversary, no meeting day, etc. Weight handler 114 may learn these preferences and company policies over time and use the preferences and company polices in generating weights for future blocks. As another example, weight handler 114 may use user preference (e.g. as discussed herein with respect to constraint interpreter 110) to weight events, blocks, etc.

Processor 102 may execute instructions of schedule optimizer 116 to determine a schedule including each block in the set of blocks. The schedule may be based on the set of temporal constraints and the weight of each block in the set of blocks. The schedule may include the minimum period of uninterrupted work time for the user (e.g. as discussed herein with respect to constraint interpreter 110). Schedule optimizer 116 may use an optimization algorithm to balance the competing weights, schedules and availability of the blocks to find time. One example optimization algorithm that may be used is a knapsack problem algorithm, although other optimization algorithms and/or combination of optimization algorithms can be used by schedule optimizer 116. Schedule optimizer 116 may balance the availability of all participants for an event (if applicable) to find a time within the requested time frame.

Schedule optimizer 116 may also receive new and/or updated events and/or temporal constraints. When these are received, schedule optimizer 116 may determine if the new event/temporal constraints conflicts with one or more blocks on the schedule. If schedule optimizer 116 determines that there is a conflict, schedule optimizer 116 may move a previously scheduled event(s) with lighter weight than the new event/temporal constraint. Schedule optimizer 116 may continue to unschedule blocks and re-optimize the schedule. Schedule optimizer 116 may schedule, reschedule and/or unschedule 1 event at a time, all events at the same time, a subset of the events at the same time, etc.

Processor 102 may execute instructions of interruption handler 118 to receive an updated temporal constraint corresponding to a change in a scheduled event included in the schedule and add the updated time constraints to the set of temporal constraints. Schedule optimizer 116 may determine a second schedule based on the set of temporal constraints and the updated temporal constraint.

Interruption handler 118 may identify an interruption in a scheduled block in the schedule, determine an amount of time of the interruption and readjust the schedule based on the set of temporal constraints. Interruption handler 118 may automatically detect an interruption in a scheduled block of time. For example, interruption handler 118 may perform an analysis on a call log to determine that a scheduled call was interrupted during a scheduled work time, may perform an analysis on an email client to determine if an e-mail review period was interrupted, etc.

Interruption handler 118 may reschedule a first event corresponding to the scheduled block for a new time period equal to an originally scheduled amount of time to be allotted for the scheduled block minus the amount of time of the interruption. This may be especially useful when the interruption handler reschedules a block of time for a primary job responsibility. This allows a users schedule to be adjusted while still scheduling a time for performing primary job responsibilities.

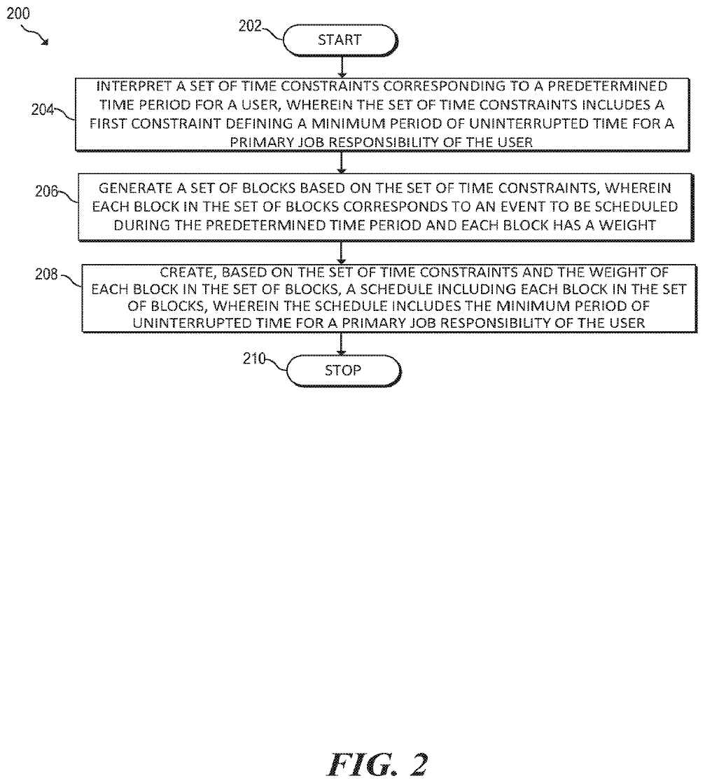

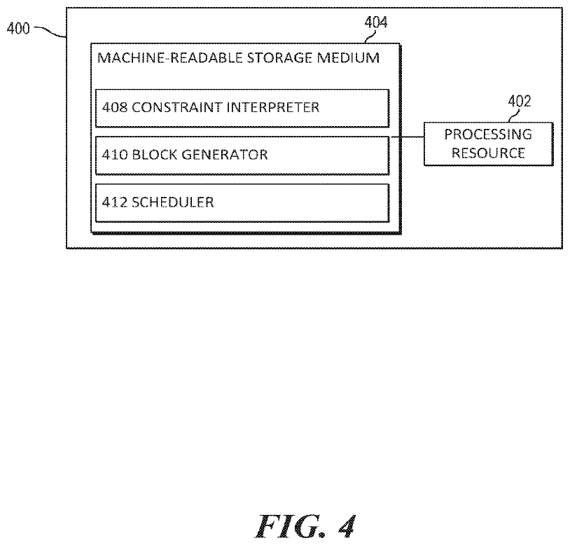

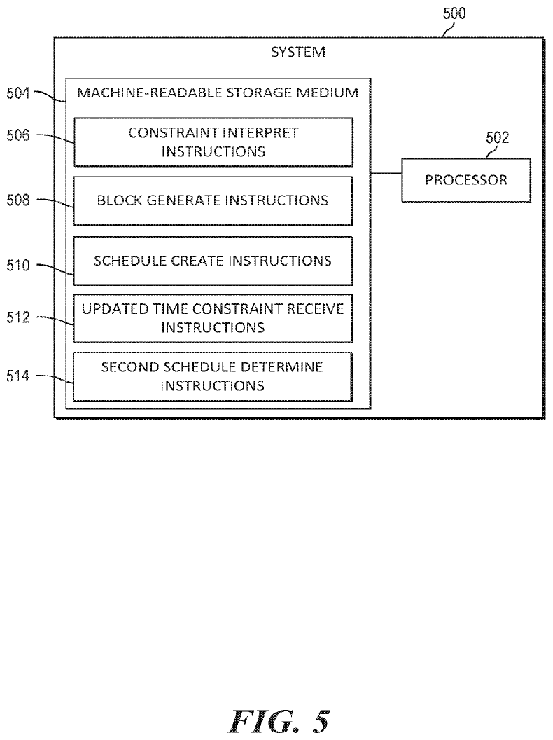

FIG. 2 is a flowchart of an example method 200 for schedule creation. Method 200 may be described below as being executed or performed by a system, for example, system 100 of FIG. 1, system 400 of FIG. 4 or system 500 of FIG. 5. Other suitable systems and/or computing devices may be used as well. Method 200 may be implemented in the form of executable instructions stored on at least one machine-readable storage medium of the System and executed by at least one processor of the system. The processor may include a Central Processing Unit (CPU) or another suitable hardware processor. The machine-readable storage medium may be non-transitory. Method 200 may be implemented in the form of electronic circuitry (e.g., hardware). At least one block of method 200 may be executed substantially concurrently or in a different order than shown in FIG. 2. Method 200 may include more or less blocks than are shown in FIG. 2. Some of the blocks of method 200 may, at certain times, be ongoing and/or may repeat.

Method 200 may start at block 202 and continue to block 204, where the method may include interpreting a set of temporal constraints corresponding to a predetermined time period for a user. Interpreting the set of temporal constraints may include receiving a temporal constraint and converting the constraint into logic statement or other format useful in creating and/or optimizing a schedule. The set of temporal constraints may include a first constraint defining a minimum period of uninterrupted time for a primary job responsibility of the user. The temporal constraint may include an activity and an amount of time to be allotted for that activity. Temporal constraints may correspond to time based obligations and/or requests for a user over a given period of time.

At block 206, the method may include generating a set of blocks based on the set of temporal constraints. Generating a set of blocks may include creating the blocks and assigning a preliminary scheduled time and date for each block. Each block in the set of blocks may correspond to an event to be scheduled during the predetermined time period and each block may have a weight. At block 208, the method may include creating, based on the set of temporal constraints and the weight of each block in the set of blocks, a schedule including each block in the set of blocks. The schedule may include the minimum period of uninterrupted time for a primary job responsibility of the user. Method 200 may eventually continue to block 210, where method 200 may stop.

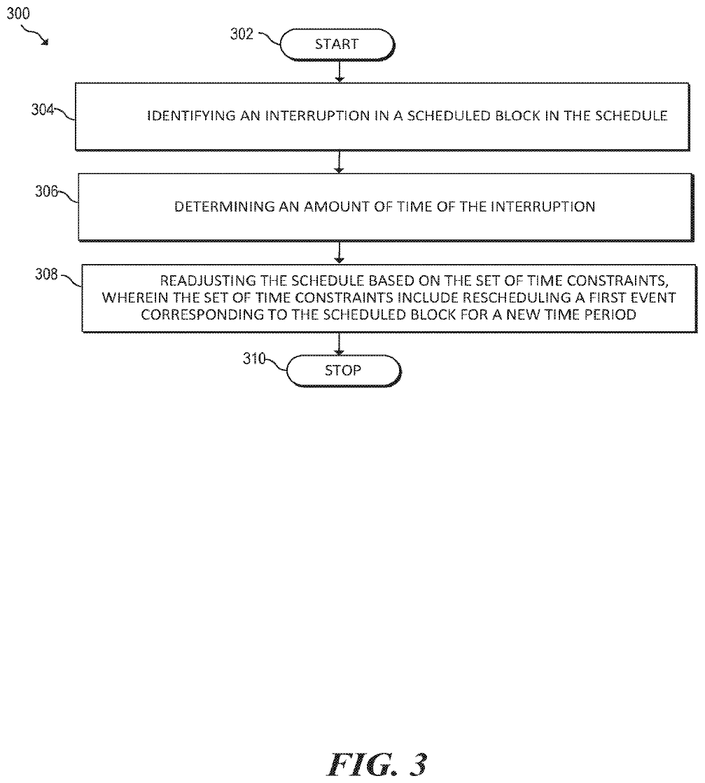

FIG. 3 is a flowchart of an example method 300 for schedule adjustment based on an interruption. Method 300 may be described below as being executed or performed by a system, for example, system 100 of FIG. 1, system 400 of FIG. 4 or system 500 of FIG. 5. Other suitable systems and/or computing devices may be used as well. Method 300 may be implemented in the form of executable instructions stored on at least one machine-readable storage medium of the system and executed by at least one processor of the system. The processor may include a Central Processing Unit (CPU) or another suitable hardware processor. The machine-readable storage medium may be non-transitory. Method 300 may be implemented in the form of electronic circuitry (e.g., hardware). At least one block of method 300 may be executed substantially concurrently or in a different order than shown in FIG. 3. Method 300 may include more or less blocks than are shown in FIG. 3. Some of the blocks of method 300 may, at certain times, be ongoing and/or may repeat.

Method 300 may start at block 302 and continue to block 304, where the method may include identifying an interruption in a scheduled block in the schedule. At block 306, the method may include determining an amount of time of the interruption. At block 308, the method may include readjusting the schedule based on the set of temporal constraints. The set of temporal constraints may include rescheduling a first event corresponding to the scheduled block for a new time period equal to an originally schedule amount of time to be allotted for the scheduled block minus the amount of time of the interruption. Method 300 may eventually continue to block 310, where method 300 may stop.

FIG. 4 is a block diagram of an example system 400 for schedule creation. System 400 may include a processing resource 402 and a memory 404 that may be coupled to each other through a communication link (e.g., a bus). Processing resource 402 may include a Central Processing Unit (CPU) or another suitable hardware processor. In some examples, memory 404 stores machine readable instructions executed by processing resource 402 for operating system 400. Memory 404 may include any suitable combination of volatile and/or non-volatile memory, such as combinations of Random Access Memory (RAM), Read-Only Memory (ROM), flash memory, and/or other suitable memory.

Memory 404 stores instructions to be executed by processing resource 402 including instructions for a constraint interpreter 408, a block generator 410 and a scheduler 412. The components of system 400 may be implemented in the form of executable instructions stored on at least one machine-readable storage medium of system 400 and executed by at least one processor of system 400. The machine-readable storage medium may be non-transitory. In other examples, each of the components of system 400 may be implemented in the form of at least one hardware device including electronic circuitry for implementing the functionality of the component.

Processing resource 402 may execute instructions of constraint interpreter 408 to interpret a set of temporal constraints corresponding to time requests for a user during a given time period. Interpreting the set of temporal constraints may include may include receiving a temporal constraint and converting the constraint into logic statement or other format useful in creating and/or optimizing a schedule. The set of temporal constraints may include a first constraint defining a minimum period of uninterrupted time for a primary job responsibility of the user. The temporal constraint may include an activity and an amount of time to be allotted for that activity. Temporal constraints may correspond time based obligations and/or requests for a user over a given period of time.

Processing resource 402 may execute instructions of block generator 410 to generate a set of blocks based on the set of temporal constraints. Generating a set of blocks may include create the blocks and assigning a preliminary scheduled time and date for each block. Each block in the set of blocks may correspond to an event to be scheduled during the predetermined time period and each block may have a weight. Each block in the set of blocks may include a preliminary scheduled time and date for at least one event within the time period. Processing resource 402 may execute instructions of scheduler 412 to create, based on the set of temporal constraints, a schedule including each block in the set of blocks, to meet the time requests for the user during the given time period.

FIG. 5 is a block diagram of an example system 500 for schedule creation. System 500 may be similar to system 100 of FIG. 1, for example. In the example illustrated in FIG. 5, system 500 includes a processor 502 and a machine-readable storage medium 504. Processor 502 may include a Central Processing Unit (CPU) or another suitable hardware processor. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 502 may be at least one central processing unit (CPU), microprocessor, and/or other hardware devices suitable for retrieval and execution of instructions stored in machine-readable storage medium 504. In the example illustrated in FIG. 5, processor 502 may fetch, decode, and execute instructions 506, 508, 510, 512 and 514 to perform schedule creation. Processor 502 may include at least one electronic circuit comprising a number of electronic components for performing the functionality of at least one of the instructions in machine-readable storage medium 504. With respect to the executable instruction representations (e.g., boxes) described and shown herein, it should be understood that part or all of the executable instructions and/or electronic circuits included within one box may be included in a different box shown in the figures or in a different box not shown.

Machine-readable storage medium 504 may be any electronic, magnetic, optical, or other physical storage device that stores executable instructions. Thus, machine-readable storage medium 504 may be, for example. Random Access Memory (RAM), an Electrically-Erasable Programmable Read-Only Memory (EEPROM), a storage drive, an optical disc, and the like. Machine-readable storage medium 504 may be disposed within system 500, as shown in FIG. 5. In this situation, the executable instructions may be “installed” on the system 500. Machine-readable storage medium 504 may be a portable, external or remote storage medium, for example, that allows system 500 to download the instructions from the portable/external/remote storage medium. In this situation, the executable instructions may be part of an “installation package”. As described herein, machine-readable storage medium 504 may be encoded with executable instructions for context aware data backup. The machine-readable storage medium may be non-transitory.

Referring to FIG. 5, constraint interpret instructions 506, when executed by a processor (e.g., 502), may cause system 500 to interpret a set of temporal constraints corresponding to a predetermined time period for a user. Interpreting the set of temporal constraints may include may include receiving a temporal constraint and converting the constraint into logic statement or other format useful in creating and/or optimizing a schedule. The set of temporal constraints may include a first temporal constraint defining a minimum period of time for a first event. The temporal constraint may include an activity and an amount of time to be allotted for that activity. Temporal constraints may correspond time based obligations and/or requests for a user over a given period of time.

Block generate instructions 508, when executed by a processor (e.g., 502), may cause system 500 to generate a set of blocks based on the temporal constraints. Generating a set of blocks may include create the blocks and assigning a preliminary scheduled time and date for each block. Each block in the set of blocks may include a preliminary scheduled time and date for at least one event within the predetermined time period. Each block in the set of blocks may correspond to an event to be scheduled during the predetermined time period and each block may have a weight.

Schedule create instructions 510, when executed by a processor (e.g., 502), may cause system 500 to create, based on the set of temporal constraints, a schedule including each block in the set of blocks. The schedule may include the first event scheduled for at least the minimum amount of time. Updated temporal constraint instructions 512, when executed by a processor (e.g., 502), may cause system 500 to receive an updated temporal constraint corresponding to a change in a scheduled event included in the schedule. Second schedule determine instructions 514, when executed by a processor (e.g., 502), may cause system 500 to determine based on the set of temporal constraints and the updated temporal constraint, a second schedule.

The foregoing disclosure describes a number of examples for schedule creation. The disclosed examples may include systems, devices, computer-readable storage media, and methods for schedule creation. For purposes of explanation, certain examples are described with reference to the components illustrated in FIGS. 1-5. The functionality of the illustrated components may overlap, however, and may be present in a fewer or greater number of elements and components. Further, all or part of the functionality of illustrated elements may co-exist or be distributed among several geographically dispersed locations. Further, the disclosed examples may be implemented in various environments and are not limited to the illustrated examples.

Further, the sequence of operations described in connection with FIGS. 1-5 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples.

1. A method comprising:
interpreting a set of temporal constraints corresponding to a predetermined time period for a user, wherein the set of temporal constraints includes a first constraint defining a minimum period of uninterrupted time for a primary job responsibility of the user;
generating a set of blocks based on the set of temporal constraints, wherein each block in the set of blocks corresponds to an event to be scheduled during the predetermined time period and each block has a weight, wherein the weight corresponds to an importance of the event; and
creating, based on the set of temporal constraints and the weight of each block in the set of blocks using an algorithm that solves a knapsack problem, a schedule including each block in the set of blocks, wherein the schedule includes the minimum period of uninterrupted time for a primary job responsibility of the user, wherein at least one block associated with a lighter weight is moved in the schedule before a block associated with a greater weight.

2. The method of claim 1 further comprising:
determining a buffer constraint based on the run time of a previous event that occurred during a previous predetermined time period; and
including the buffer constraint in the set of temporal constraints.

3. The method of claim 1 further comprising:
interpreting a user constraint defining a date and a time for at least one event; and
including the user constraint in the set of temporal constraints.

4. The method of claim 1 further comprising:
adjusting a weight of a first block in the schedule based on the proximity of the time block to the end of the predetermined time period.

5. The method of claim 1 further comprising:
interpreting a constraint defining a maximum amount of time for a particular type of activity during the predetermined time period.

6. The method of claim 1 further comprising:
increasing the weight of a block based on an organizational hierarchy of a company employing the user and another participation in a first event corresponding to the block.

7. The method of claim 1 wherein the temporal constraints correspond to time based obligations for a user over a given period of time.

8. The method of claim 1 further comprising:
interpreting an interruption in a scheduled block in the schedule;
determining an amount of time of the interruption; and
readjusting the schedule based on the set of temporal constraints, wherein the set of temporal constraints include rescheduling a first event corresponding to the scheduled block for a new time period equal to an originally schedule amount of time for the scheduled block minus the amount of time of the interruption.

9. A system comprising:
a processing resource; and
a machine-readable storage medium comprising instructions executable by the processing resource to:
interpret a set of temporal constraints corresponding to time requests for a user during a given time period;
generate a set of blocks based on the set of temporal constraints, wherein each block in the set of blocks includes a preliminary scheduled time and date for at least one event within the time period and has at least one weight that corresponds to an importance of the at least one event; and
create, based on the set of temporal constraints using an algorithm that solves a knapsack problem, a schedule including each block in the set of blocks, to meet the time requests for a user during a given time period, wherein at least one block associated with a lighter weight is moved in the schedule before a block associated with a greater weight.

10. The system of claim 9, wherein the time requests include a block of uninterrupted work time.

11. The system of claim 9 wherein the machine-readable storage medium further comprises instructions executable by the processing resource to:
identify an interruption in a scheduled block during the predetermined time period;
determine an amount of time of the interruption; and
to adjust the schedule based on the set of temporal constraints, wherein the set of temporal constraints include rescheduling the scheduled block for a new time period equal to an originally schedule amount of time for the scheduled block minus the amount of time of the interruption.

12. The system of claim 9 wherein the machine-readable storage medium further comprises instructions executable by the processing resource to:
to receive a constraint defining a maximum amount of time for a particular type of activity during the predetermined time period.

13. A non-transitory machine-readable storage medium comprising instructions, the instructions executable by a processor of a system to cause the system to:
interpret a set of temporal constraints corresponding to a predetermined time period for a user, wherein the set of temporal constraints includes a first temporal constraint defining a minimum period of time for a first event;
generate a set of blocks based on the temporal constraints, wherein each block in the set of blocks includes a preliminary scheduled time and date for at least one event within the predetermined time period and a weight;
create, based on the set of temporal constraints, a schedule including each block in the set of blocks using an algorithm that solves a knapsack problem, wherein the schedule includes the first event scheduled for at least the minimum amount of time;
receive an updated temporal constraint corresponding to a change in a scheduled event included in the schedule; and
determine based on the set of temporal constraints and the updated temporal constraint, a second schedule, wherein at least one block associated with a lighter weight is moved in the second schedule before a block associated with a greater weight.

14. The non-transitory machine-readable storage medium of claim 13, wherein the instructions executable by the processor of the system further cause the system to:
receive a user constraint defining a date and a time for at least one event in the set of events.

15. The non-transitory machine-readable storage medium of claim 13, wherein the instructions executable by the processor of the system further cause the system to: adjust a weight of a first time block based on the proximity of the time block to the end of the time period.
